(19) United States
(12) Patent Application Publication
(10) Pub. No.: US 2008/0261597 A1
(43) Pub. Date: Oct. 23, 2008

(54) HANDOFF METHOD BETWEEN DIFFERENT SYSTEMS AND WIRELESS TERMINAL

(76) Inventors: Masao Hayama, Yokohama (JP); Koichi Shiraishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/029,701

(22) Filed: Feb. 12, 2008

(30) Foreign Application Priority Data
Apr. 18, 2007 (JP) 2007-108808

(51) Int. Cl. H04Q 7/20; H04M 1/00

(52) U.S. Cl. 455/436; 455/552.1

(57) ABSTRACT

A method of performing a handoff between a plurality of wireless systems having different service areas and a wireless communication terminal are provided. A means for selecting one of the wireless systems to be connected according to the average moving speed of the wireless terminal is provided. When the average moving speed is changed across a certain threshold, the wireless terminal starts selecting one of the wireless systems as a handoff destination. Upon selection of the handoff destination, the current throughput is compared with the estimated throughput of the handoff destination. When an improvement in the throughput can be expected, the wireless terminal performs the handoff. The wireless terminal incorporates a plurality of control devices to select the handoff destination while communicating with the current wireless system.

### INCORPORATION BY REFERENCE

The present application claims priority from Japanese application JP2007-108808 filed on Apr. 18, 2007, the content of which is hereby incorporated by reference into this application.

### BACKGROUND OF THE INVENTION

The present invention relates to handoff techniques in wireless communication systems and more particularly, to a handoff technique for performing handoff processing operation between different wireless communication systems in an area in which wireless systems based on a plurality of wireless communication schemes are present.

In the handoff between sectors in an identical wireless communication system, when the power intensity of a pilot signal received from another sector as a handoff destination candidate exceeds a certain threshold and the pilot signal is received at a wireless terminal, or when the power intensity of a pilot signal received from the sector currently being connected is smaller than the certain threshold and the pilot signal is received at the wireless terminal, the wireless terminal, in response to it, informs the wireless base station being connected of the fact that the received power of the other sector became stronger than the received power of the current sector. Information transmitted via the wireless base station is processed by a control device which performs call processing, and the control device determines a sector as a handoff target and then instructs the wireless terminal to perform the handoff.

When it is desired to perform handoff processing operation between two wireless systems of different wireless communication schemes, there are two methods, one governed, similarly to a technique in an identical wireless system, by a wireless terminal which compares the received power intensity of a pilot signal transmitted from another wireless system with that of the current wireless system to request the handoff processing operation; and the other governed by an access network having a call controller which requests the handoff processing operation to upgrade the wireless system to a wireless system having a higher communication quality due to the degradation of the current wireless system. In both of the handoff within the same wireless system and the handoff between different wireless systems, when the timing of the handoff is informed to the controller mainly under control of a wireless terminal, the handoff timing is basically when such electric wave environment as the received power intensity of the aforementioned pilot signal from the base station is degraded. The handoff timing is also considered to be not only when the received power intensity of the pilot signal is degraded but also when a throughput is decreased or a packet error is increased.

The handoff is also performed not only on the basis of the degradation of the aforementioned communication quality but also on the basis of the moving speed of the wireless terminal. JP-A-2003-87848 discloses a method of performing a handoff at the timing of a threshold in the moving speed of a wireless terminal between two different wireless systems.

### SUMMARY OF THE INVENTION

It is desirable to connect a wireless terminal to the optimum wireless communication system according to user's use manner or moving state, and thus such a method as to perform a handoff between wireless systems of two or more different wireless communication schemes is required. Wireless base stations in the wireless systems are installed to transmit electric waves with different powers by utilizing features of the different wireless communication schemes, and the service areas covered by the wireless base stations are not necessarily overlapped with each other. For example, when a wireless communication service is provided only for customers within a building, it is unnecessary to expand the service area. Thus a wireless communication scheme of a microcell, which has a small service area but has a relatively high average throughput, is employed. In general, a wireless system having a small cell radius is less influenced by the interference of noise or the like, because a distance between a base station and a terminal is small. Thus since a reception power can become high and a multilevel modulation scheme can be employed, a throughput can be made high.

Even when a service based on a different wireless system is provided within the building, in most cases, the different service is present within a service area based on a macrocell wireless scheme having a large service area considering high speed movement. In this case, when the user of a wireless terminal starts its communication outside of the building and the user enters the building, the wireless terminal cannot be connected to the wireless system of the high speed service provided only within the interior of the building. And in some cases, user's entrance into the building causes degradation of an electric wave state with the current wireless system, thus reducing a throughput or cutting off a call. In this way, when service areas of a plurality of wireless systems are overlapped with each other, it is desirable to select one of the wireless systems providing a higher throughput and to perform a handoff according to the location of the wireless terminal. When the wireless terminal is being moved at a high speed, however, connection of the wireless terminal with a wireless system having a small service area causes frequent handoff, with the result that some wireless system cannot follow up the moving speed of the wireless terminal and conversely this involves deterioration of the communication quality. Mere handoff of the wireless terminal to a wireless system having a small service area and having a high throughput based on the wireless communication scheme causes an increase in the number of connections to wireless terminals in the wireless system, thus resulting in a reduction in the throughput per wireless terminal.

It is therefore an object of the present invention, in an area having a plurality of wireless systems based on different wireless communication schemes present therein, to enable a wireless terminal to select one of the wireless systems having a suitable service area and to enable the wireless terminal to have a high throughput by utilizing the selected wireless system.

In accordance with an aspect of the present invention, the above object is attained by a method of performing a handoff between a plurality of wireless communication systems using a wireless terminal. The wireless terminal includes a plurality of communication processors compatible with the plurality of wireless communication systems of ranks previously determined and having different service areas and different throughputs respectively; at least two antennas; at least two wireless communication units for transmitting or receiving an electric wave in any of the communication systems of the communication processors via the antennas; a switch for switching between the plurality of communication processors and the wireless communication units; a controller for controlling constituent elements of the wireless terminal; and a terminal state detector. Each of the plurality of wireless communication systems includes a base station; and a call control device having handoff processing means connected to another base station of another of the wireless communication systems for performing handoff processing operation between the plurality of wireless communication systems. The controller selects one of the wireless communication systems having a rank satisfying the condition and determines a communication quality in the selected wireless communication system when a terminal state detected by the terminal state detector satisfies a predetermined condition. And, the wireless terminal transmits a handoff determination request to the selected wireless communication system via the wireless communication unit and the antenna when an improvement in the communication quality is expected. The call control device when receiving the handoff determination request determines permission or non-permission of the handoff processing operation and transmits a handoff permission/non-permission determination result to the wireless terminal. The wireless terminal selects one of the wireless communication systems on the basis of the handoff permission/non-permission determination result in such a manner that when the handoff permission/non-permission determination result is permission, the wireless terminal performs the handoff. And, when the handoff permission/non-permission determination result is non-permission, the wireless terminal selects the wireless communication system of another rank. When the selected wireless communication system is other than the wireless communication system currently being selected, the wireless terminal transmits a handoff determination request via the wireless communication unit and the antenna.

In the aspect of the present invention, more specifically, when service areas of the plurality of wireless systems are overlapped with each other and even when a pilot signal of the wireless system currently in communication has a sufficient intensity, one of the wireless systems providing a high throughput is selected considering the moving state of the wireless terminal. When the communication qualities of the other wireless systems are monitored at all times, the power consumption of the wireless terminal becomes high. To avoid this, in the present invention, the wireless terminal will not always monitor the pilot signals of the other wireless systems, but be arranged to start selecting a handoff to another wireless system when the average moving speed of the wireless terminal is changed across a certain threshold and decreased down to the certain threshold, and to perform the handoff when the wireless terminal determines that the communication quality of the handoff destination is better than the handoff originator.

In some moving state of the wireless terminal, the handoff to a wireless system having a large service area can prevent, in some cases, frequent generation of deterioration in the communication quality of the handoff within the same wireless system. Even in such a case, the wireless terminal selects and starts the handoff to another wireless system when the average moving speed of the wireless terminal is changed across a certain threshold and increased up to the certain threshold. And when the wireless terminal determines that the communication quality of the handoff destination is better than the communication quality of the handoff originator, the wireless terminal performs the handoff.

Actual handoff to another wireless system is determined based on comparison in throughput between the handoff originator and destination. At this time, when the wireless terminal uses a wireless up-link of application software based mainly on such up-link as upload, determination of the handoff to another wireless system based on a down-link communication quality does not lead always to an improvement in the up-link communication quality of the handoff destination. Thus the handoff to another wireless system is arranged to be performed on the basis of the communication quality of either the up- or down-link as a reference according to the amount of communication data of the wireless terminal to the up- or down-link.

Wireless systems are ranked according to the size of a service area and an average throughput. When the wireless terminal is not expected to be improved in the communication quality in the wireless system of a rank defined by a threshold of the average moving speed, the wireless systems of lower ranks are sequentially selected and the wireless terminal inquires of the call control device of the selected wireless system as a handoff destination candidate about expectancy of an improvement in the communication quality. When the rank of the wireless system selected at the first handoff timing is higher than the rank of the current wireless system as when the average moving speed is changed across the threshold and decreased down to the threshold, the rank of the wireless system is sequentially lowered until the rank becomes the same as the rank of the current wireless system, and it is confirmed whether or not the communication quality is expected to be improved with the wireless system of the rank. Conversely when the rank of the wireless system selected at the first handoff timing is lower than the rank of the current wireless system as when the average moving speed is changed across a threshold and increased up to the threshold, the rank of the wireless system is sequentially lowered down to the lowest one of the ranks of the wireless systems selected as handoff destination candidates, and it is confirmed whether or not the communication quality is expected to be improved with the wireless system of the rank. In either case, when the handoff is not expected to be improved in the communication quality, handoff to another wireless system is not performed and a handoff to another sector within the current wireless system is performed as necessary.

For the purpose of enabling communication with service areas having different wireless communication schemes, the wireless terminal incorporates not only communication units of the wireless communication schemes but also a plurality of wireless units of the wireless schemes for selecting handoff destinations of the wireless systems of the different wireless communication schemes while communicating with the current wireless system. To this end, the wireless terminal also incorporates a GPS receiver and a speed sensor to measure the moving speed of the wireless terminal and the position thereof. Since not only the handoff based on the average moving speed but also the handoff based on the intensity of the pilot signal is added, a terminal located at a boundary between service areas not continuous to each other can be relieved. In this case, when the intensity of the pilot signal received at the wireless terminal is lower than a threshold, the wireless terminal starts selecting handoff destination candidates.

Since a wireless system having a high throughput is selected considering the moving state of the wireless terminal, a throughput per user can be made high.

Other objects, features and advantages of the invention will become apparent from the following description of the embodiments of the invention taken in conjunction with the accompanying drawings.

### BRIEF DESCRIPTION OF THE DRAWINGS

FIG. 1 shows a diagram for explaining an arrangement of wireless communication systems to which the present invention is applied;

FIG. 2 shows a functional block diagram of a call control device in an embodiment of the present invention;

FIG. 3 shows an arrangement of a wireless terminal in the embodiment of the present invention;

FIG. 4 is a graph for explaining a relation between the average moving speed of the wireless terminal and handoff determination thresholds when an abscissa axis denotes time;

FIGS. 5A and 5B show an example of data held in the wireless terminal;

FIG. 6 shows an example of data held in a wireless base station;

FIG. 7 is a flowchart of a handoff destination selection process regularly carried out by the wireless terminal;

FIG. 8 is a flowchart after the wireless terminal selects a handoff destination candidate until the wireless terminal transmits a handoff processing request;

FIG. 9 is a flowchart when the current wireless system is selected in the handoff destination selection process;

FIG. 10 is a flowchart for explaining a handoff determination process in the call control device;

FIG. 11 shows an example of an estimated throughput coefficient graph of the wireless communication system;

FIG. 12 is a processing flowchart when the wireless terminal receives a handoff determination result; and

FIG. 13 is a sequence chart of handoff between different systems.

### DETAILED DESCRIPTION OF THE EMBODIMENTS

Explanation will be made as to an embodiment of the present invention by referring to the accompanying drawings.

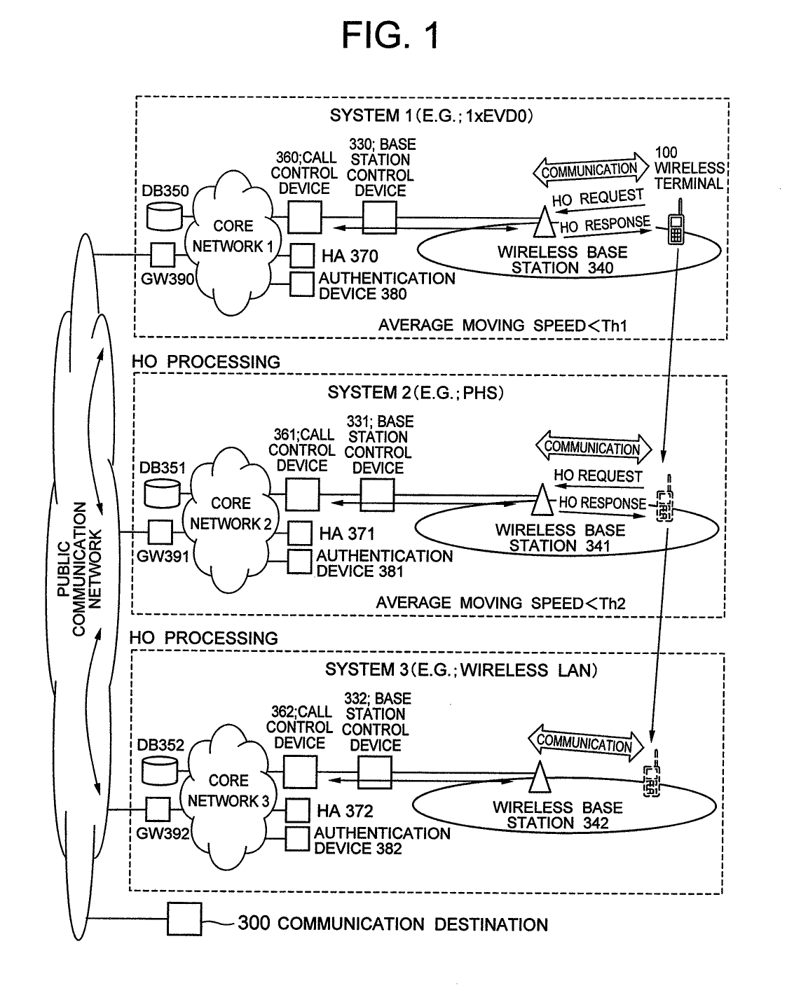

FIG. 1 shows an example of service areas of wireless systems based on different wireless communication schemes.

System 1 (e.g., 1xEVDO), a system 2 (e.g., PHS), and a system 3 (e.g., wireless LAN) are wireless systems based on different communication schemes, which have different sizes of service areas partly overlapped with each other. The system 1 includes a wireless base station 340 for communicating with a wireless terminal; a base station control device 330 for controlling the wireless base station 340; a call control device 360 for controlling call processing such as call connection or handoff within the same wireless system and also controlling handoff between wireless systems; an HA 370 (home agent) for transmitting packets directed to the wireless terminal to the wireless terminal; an authentication device 380 for authenticating a connection of the wireless terminal or for performing billing operation; a DB 350 for storing statistics information, maintenance information, and user information; and a GW 390 for connecting a core network 1 with a public communication network. The core network 1 has switches and transmission lines for interconnection between the aforementioned constituent devices. Similar to the system 1, the system 2 includes a wireless base station 341, a base station control device 331, a call control device 361, an HA 371, an authentication device 381, a DB 351, a core network 2, and a GW 391. The system 3 similarly includes a wireless base station 342, a base station control device 332, a call control device 362, an HA 372, an authentication device 382, a DB 352, a core network 3, and a GW 392.

In the example of FIG. 1, a wireless terminal 100 is assumed to be first communicating with a communication destination 300 such as an application server via the system 1 and the public communication network. The wireless terminal 100 is communicating with the destination via the system 1 in a service area of the system and moving at a certain speed toward an area connectable with all of the systems 1, 2 and 3. When the average moving speed of the wireless terminal 100 becomes lower than a threshold Th1, the wireless terminal 100 scans the system 2 as a handoff destination candidate to search for broadcasting information thereabout, and transmits a handoff processing request with the wireless system to a call control device 360 of the system 1. The call control device 360, when receiving the handoff processing request starts performing handoff processing operation to the call control device 361 of the system 2 as a handoff destination candidate. When determining that, after the handoff to the call control device 361 of the handoff destination wireless system, an improvement in the communication quality is expected; the wireless terminal 100 transmits a handoff permission to the call control device 360. The call control device 360 in turn informs the wireless terminal 100 of the permitted handoff as a handoff response. Thereafter, in response to the handoff processing request from the wireless terminal 100, the wireless terminal 100 is switched through exchange of call information between the systems 1 and 2, so that the wireless terminal 100 starts communicating with the system 2.

Later, when the average moving speed of the wireless terminal 100 becomes lower than a threshold Th2, the wireless terminal 100 searches for the system 3 as a handoff destination candidate, and transmits a handoff determination request with the wireless system to the call control device 361 of the system 2. When receiving the handoff determination request, the call control device 361 transmits the handoff determination request to the call control device 362 of the system 3 as the handoff destination candidate, and the call control device 361 itself determines the handoff. When the call control device 362 of the handoff destination wireless system determine that an improvement in the communication quality is expected after the handoff, it transmits the handoff permission to the call control device 361 as a handoff determination result. The call control device 361 in turn informs the wireless terminal 100 of the permitted handoff as the handoff determination result. Thereafter, in response to the handoff processing request from the wireless terminal 100, the wireless terminal 100 is switched by the exchange of the call information between the systems 2 and 3, so that the wireless terminal 100 starts communicating with the system 3. In the handoff across the wireless systems, a mobile IP is generally used so that the home agent achieves the transfer process of packets. In the present invention, there is provided a method of selecting a handoff destination candidate according to the moving speed of the wireless terminal and, when the handoff destination finds an expectancy of an improvement in communication quality, performing the handoff processing operation.

A method of implementing a handoff will be explained.

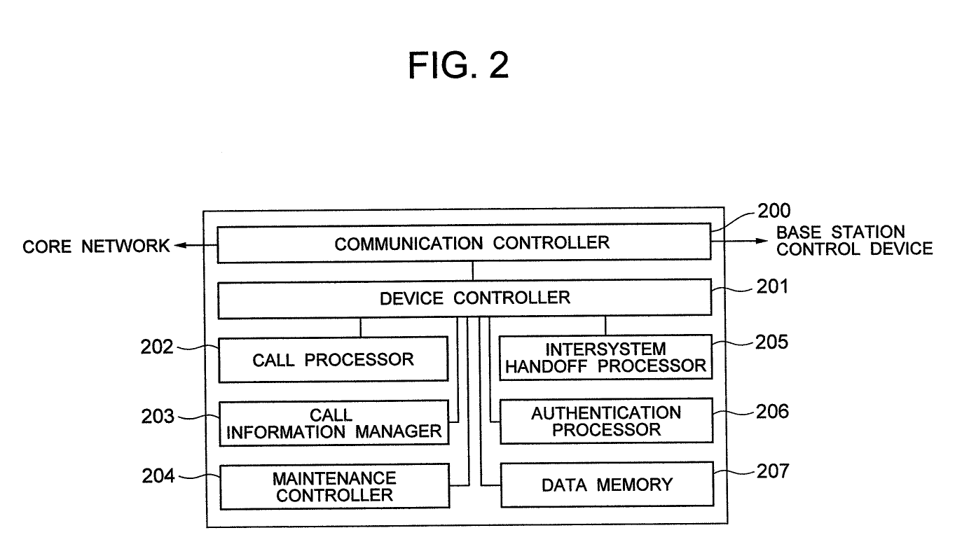

FIG. 2 is an example of a functional block diagram of the call control device.

The call control device is a device which is used when a wireless terminal within a wireless system manages and which controls a call connection or when the wireless terminal performs a handoff to another wireless system. The call control device is installed in each of the wireless systems and is implemented in the form of single hardware or a plurality of hardware. A communication controller 200 provides functions and an interface to communicate with the base station control device and with another device connected to the core network. A device controller 201 has a function of allocating resources to execute the respective function blocks of the call control device or instructing the blocks to execute the functions. The device controller 201 is connected to the functional blocks of the call control device. A call processor 202 has a function of connecting with the wireless terminal and managing the connected state and performing handoff processing operation to be connected with another wireless base station within the system, and of performing paging operation in a dormant state or collecting statistics information about each call. A call information manager 203 has a function of managing allocated parameter information and a session information necessary for the call processing of each wireless terminal. An intersystem handoff processor 205 has a function of performing handoff processing operation to cause the wireless terminal to move to another wireless system having a different core network. An authentication processor 206 has a function of authenticating the permitted connection of the wireless terminal, that is, controlling in such a manner that only the connection-permitted wireless terminal can be connected by communicating with the authentication device and collating it with registered information. A maintenance controller 204 has a function of controllably monitoring a state or a trouble in the call control device and informing a maintenance terminal in the wireless system of a state change. A data memory 207 has a function of managing a program necessary for the operation of the call control device and controllably storing data necessary for call control and setting information about a device such as the wireless base station. Since call processing at the wireless terminal is controlled by the call control device, a handoff between the wireless systems can be performed by performing transfer of call information and a control signal between the call control devices. When services of a plurality of wireless systems are provided from the same service provider, the intersystem handoff processor is not provided in each of the call control devices of the wireless systems, but can also be provided in an upper-level device which integrally monitors all of these wireless systems.

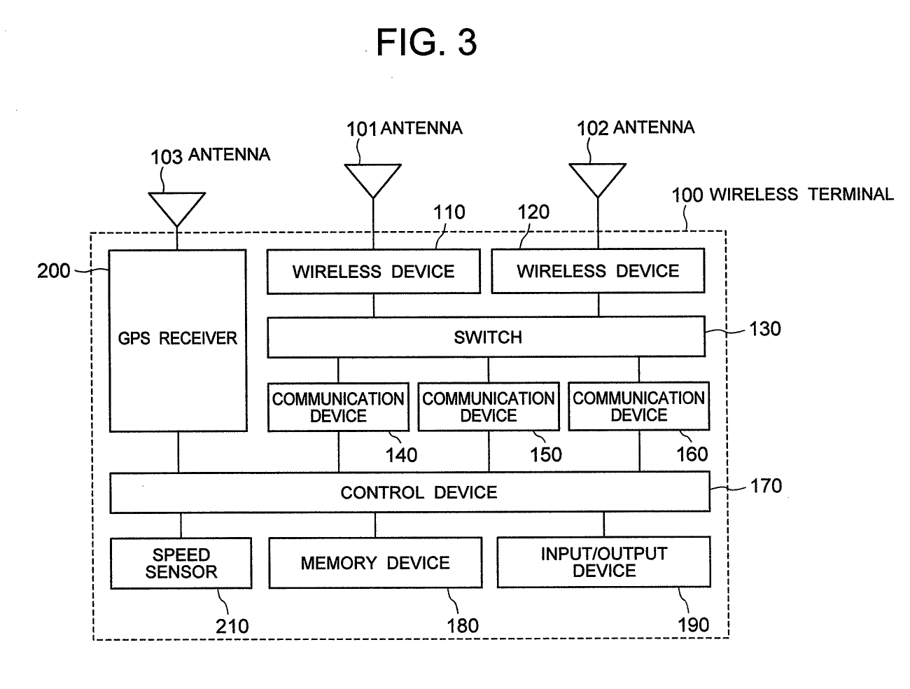

FIG. 3 shows an arrangement of the wireless terminal 100.

The wireless terminal 100 includes communication devices for each supported wireless systems for implementing handoff processing operation between wireless systems, and also includes two wireless devices for performing handoff processing operation to another wireless system during communication in the current wireless system. When two or more wireless devices are included in the wireless terminal, the wireless terminal can communicate with a plurality of wireless systems at the same time. The wireless terminal 100 has an antenna 101, an antenna 102, a wireless device 110, and a wireless device 120 for communicating with the wireless base station. Thus the wireless terminal can communicate with two wireless systems respectively at different frequencies at the same time. These wireless devices are connected to a switch 130 which can switch among two or more communication devices. Communication devices 140, 150, and 160 are compatible with wireless systems of different wireless communication schemes, and mainly perform signal modulating/demodulating or encoding/decoding operation. A control device 170 is an arithmetic device which controls the interior of the wireless terminal or initiates and executes a necessary application program. A memory device 180 stores a program such as an application program and parameters to be used in the wireless terminal, holds a communication state, and keeps user data.

The user of the wireless terminal can instruct the wireless terminal and confirm its instruction result by using such an input/output device 190 as a keyboard, a liquid crystal panel, a loudspeaker or a microphone. In the present invention, a handoff destination candidate is selected according to the average moving speed of the wireless terminal. Thus for the purpose of measuring the moving speed of the wireless terminal, a GPS receiver 200 and an antenna 103 are built in the wireless terminal. Since the position of the wireless terminal is regularly measured by the GPS receiver 200, the terminal moving speed can be calculated from a time elapsed from the previous-time measurement and from a distance. In the illustrated example, a speed sensor 210 for detecting the moving speed of the wireless terminal is also incorporated in the terminal in addition to the GPS receiver 200. However, it is not necessarily required to build the speed sensor 210 in the wireless terminal.

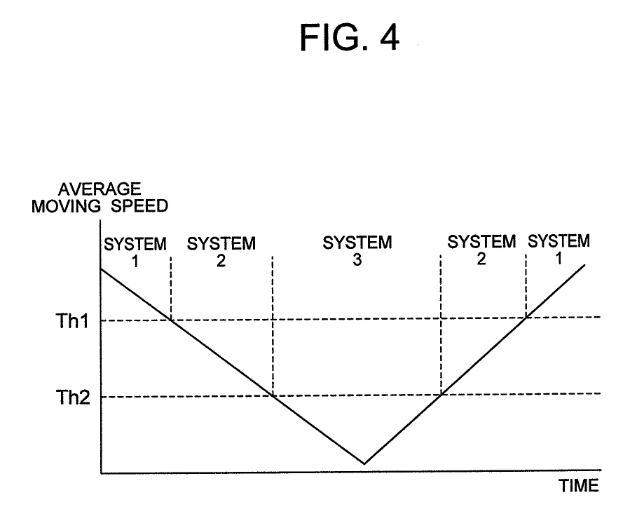

Explanation will next be made as to how to implement the handoff selecting operation using a terminal moving speed by referring to FIG. 4.

This drawing indicates average moving speed and wireless systems to be connected according to the average moving speed. In this example, there are present a system 1 which can have the largest service area and keep a communication quality even in a wireless terminal having a fast moving speed, a system 2 which can have a next-larger service area, and a system 3 which can have the smallest service area but have the highest throughput among the communication schemes. The wireless terminal is connected with a different wireless system according to its moving speed. It is assumed that the wireless terminal is first communicating with the system 1 at a certain moving speed and that the average moving speed of the wireless terminal is linearly decreased as an example. When the average moving speed of the wireless terminal is changed across Th1 and decreased down to the threshold, the wireless terminal selects, as a handoff destination candidate, the system 2 having a small service area but having a relatively high throughput among the communication schemes, and when determining that the communication quality of the system 2 is improved over the communication quality of the system 1, the wireless terminal performs a handoff. When the average moving speed of the wireless terminal connected to the system 2 is further decreased, changed across the threshold Th2 and decreased down to the threshold; the determination of improved communication quality in the handoff destination by the wireless terminal causes the wireless terminal to perform a handoff to the system 3.

Explanation will then be made in connection with an assumption that the wireless terminal communicating in the system 3 starts moving and the average moving speed of the terminal is linearly increased. When the average moving speed of the wireless terminal gradually increases and becomes higher than the threshold Th2, the wireless terminal performs a handoff to the system 2 having a next-larger service area. The increased moving speed means that the communication of the terminal with the wireless communication system having a small service area causes frequent handoff within the same wireless system, thus increasing a packet error and deteriorating its communication quality. Thus when the moving speed is increased, the wireless terminal performs a handoff to the wireless system having a wider service area.

Similarly, the moving speed of the wireless terminal connected with the system 2 is further increased and becomes higher than the threshold Th1, the wireless terminal performs a handoff to the system 1 having a much wider service area. In this way, the handoff between the wireless systems of different wireless communication schemes according to the average moving speed of the wireless terminal enables selection of the optimum wireless system based on the average moving speed and improvement of the throughput.

In the example of FIG. 4, the same threshold is used in both cases when the handoff is performed from the wireless system having a large service area to the wireless system having a small service area and when the handoff is performed from the wireless system having a small service area to the wireless system having a large service area. However, the threshold may be set to have different values. In calculation of the average moving speed, moving average is used as an example. The wireless terminal regularly calculates its own moving speed and calculates an average moving speed from the calculated moving speed using the moving average. When not the instantaneous value of the moving speed but the moving average is used, an unnecessary handoff can be prevented from being performed to another wireless system even in the case of an abrupt speed change. For example, when the value of an averaging time constant indicative of a past time for an average of past moving speeds is made large, the handoff to the wireless system can be shifted slowly when compared with an abrupt speed change. Conversely, when the averaged time constant is made small, the handoff processing operation can be started at a speed close to the current speed.

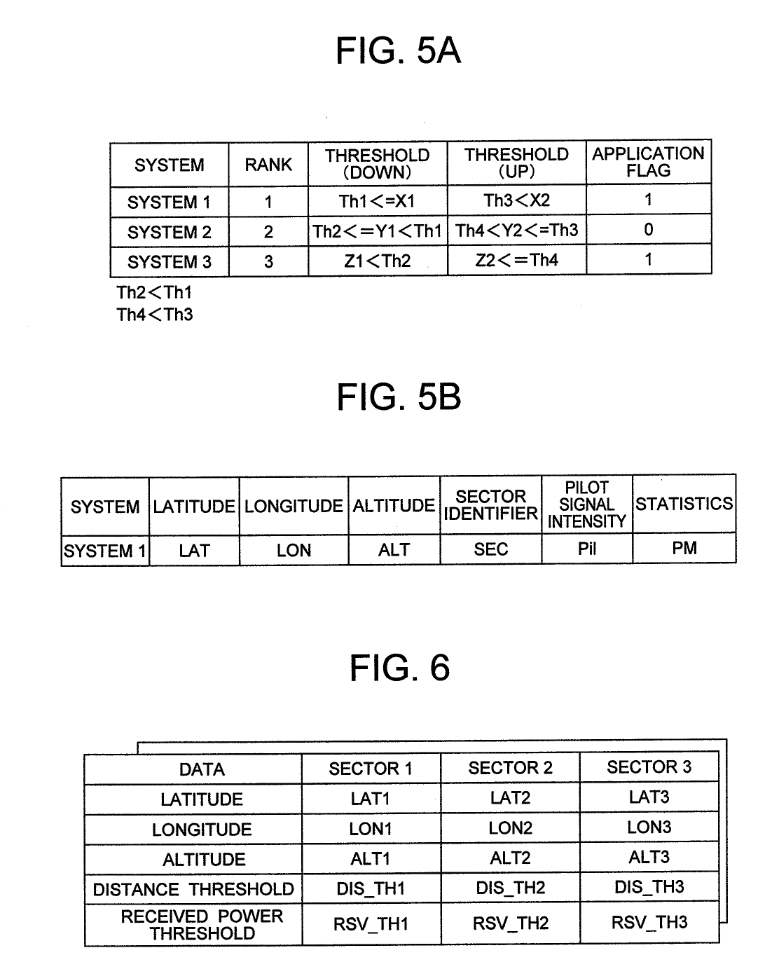

FIGS. 5A and 5B show stored data to be used when the wireless terminal selects one of the wireless systems as a handoff destination candidate.

When a wireless terminal performs a handoff to another wireless system, it is necessary to have such thresholds explained in FIG. 4. The wireless terminal calculates an average moving speed from its moving speed and regularly confirms whether or not the calculated result is changed across the defined threshold for each wireless system. To this end, the wireless terminal has information on thresholds defined for the respective wireless systems, the threshold information is informed to the wireless terminal from the wireless base station upon configuration or upon transmission of broadcasting information and is stored in the memory of the wireless terminal. Threshold (Down) refers to a value as a threshold used in determination of whether or not the average moving speed of the wireless terminal is decreased down to a level lower than the threshold when the average moving speed decreases.

Threshold (Up) refers to a value as a threshold used in determination of whether or not the average moving speed of the wireless terminal is changed across the threshold and increased up to the threshold when the average moving speed increases. The wireless terminal has rank information different for the different wireless systems, and the rank information have rank numbers applied thereto different according to throughputs or service areas of communication schemes. Application flag refers to a flag indicative of whether or not the user or a provider permits a handoff between wireless systems in a service area having a plurality of wireless systems present therein. For example, FIGS. 5A and 5B show the presence of the systems 1, 2, and 3 in a service area and permitted handoffs between these systems. However, when it is desired to allow communication with only the systems 1 and 2 for a certain user, the application flag is set to have a value of “0” for the system 2.

When it is desired to allow the handoff only within the same wireless system, it is only required to set the application flag to have a value of “1” only for a single wireless system. When the application flag is provided in this way, the wireless system as a communication target can be selected according to user's contract type or the wireless system supported by the wireless terminal. FIG. 5B shows data held when the wireless terminal selects a handoff destination. When the average moving speed of the wireless terminal is changed across the threshold, handoff processing operation is started. When the handoff processing operation is started, however, data shown in this table are transmitted to the call control device of a handoff destination candidate to be used in the processing of handoff execution determination (to be explained later). Information on latitude, longitude and altitude are acquired from the GPS receiver, and a sector identifier is acquired from broadcasting information from the wireless base station of the handoff destination candidate. A pilot intensity is the intensity of a received power when the wireless terminal captures a pilot signal from the wireless base station, and statistics information is up- and down-link throughput information managed by the wireless terminal.

FIG. 6 shows data held by a wireless base station to perform the handoff.

These information are considered when held in a database and when managed by a database and by a wireless base station. These information are managed in units of wireless base station or in units of sector for each wireless system. The information include the latitude, longitude and altitude of a wireless base station, a threshold of a distance from the wireless base station to a wireless terminal to determine the execution or non-execution of a handoff, and a threshold of a received power informed from the wireless terminal to determine execution or non-execution of the handoff. When the latitude, longitude and altitude are compared with the latitude, longitude and altitude acquired by the GPS receiver informed from the wireless terminal, a distance between the wireless base station and the wireless terminal can be calculated. When the calculated result is compared with the distance threshold, a handoff to a terminal located at a far distance can be refused. The above thresholds can be set by a service provider.

Explanation will be made as to the operation of a wireless terminal for handoff processing operation and as to the operation of a call control device as a handoff destination candidate.

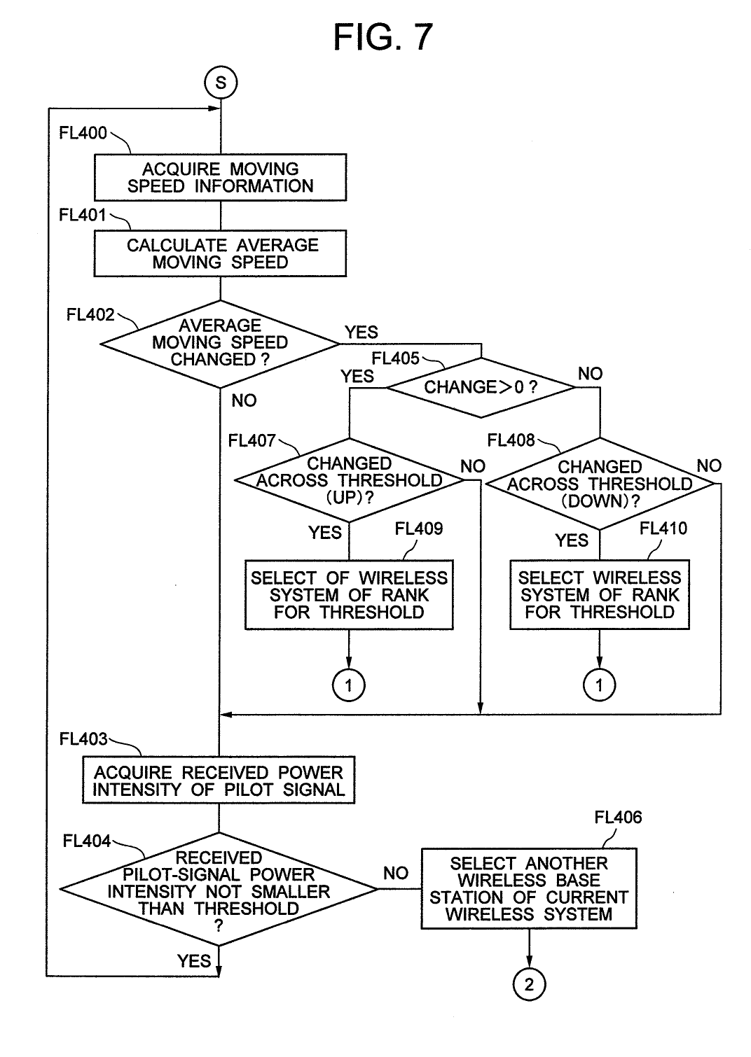

FIG. 7 shows a flowchart of a handoff destination selection process regularly carried out by a wireless terminal.

A mark “S” given in a circle means the start of the flowchart and a number means the flowchart is continued to the start of a flowchart in another drawing. In this case, it is assumed that the wireless terminal can suitably select a wireless system having an application flag of “1” set therein as a handoff destination candidate. In order that the wireless terminal performs a handoff, it is necessary to regularly calculate an average moving speed from the moving speed of the wireless terminal and to confirm whether or not the calculated result is changed across a threshold. To this end, the wireless terminal acquires moving speed information from the GPS receiver or speed sensor built therein (step FL400), and calculates an average moving speed from the acquired information (step FL401). For the calculation of the average moving speed, the moving average mentioned earlier can be used. The wireless terminal compares the calculated average moving speed with the previous average moving speed (step FL402), determines whether the average moving speed is increased or decreased (step FL405), compares the average moving speed with a threshold held in the wireless terminal explained in FIGS. 5A and 5B, and determines whether or not the average moving speed is changed across values defined by the thresholds (Down) and (Up) on the basis of the comparison result (steps FL407 and FL408). When the wireless terminal determines that the average moving speed was changed across the threshold and is lower than the threshold, the wireless terminal selects a wireless system of a rank higher by one having an application flag of “1” set therein (step FL410). When the average moving speed is higher than the threshold, the wireless terminal selects a wireless system of a rank lower by one having an application flag of “1” set therein (step FL409).

The explanation is based on ranks given in FIGS. 5A and 5B. In this connection, a high rank means a high throughput. The average moving speed lower than the threshold means the average moving speed lower than the threshold (Down), and the wireless terminal selects a wireless system having a high rank as a handoff destination candidate. Conversely since the average moving speed higher than the threshold means the average moving speed higher than the threshold (Up), the wireless terminal selects a wireless system having a low rank as a handoff destination candidate. When the average moving speed fails to change across any of the thresholds, the wireless terminal measures the intensity of a pilot signal transmitted from the wireless base station to determine the necessity or non-necessity of a handoff within the same wireless system (step FL403). This becomes the timing of start of a handoff when the wireless terminal is moving at a distance away from the wireless base station at the same moving speed. When the received power intensity of the pilot signal becomes lower than the threshold, this means that a communication quality with the wireless base station is deteriorated, and thus the wireless terminal selects another base station within the current wireless system as a handoff destination candidate (step FL406). When the received power intensity of the pilot signal is higher than the threshold, even the continuation of the communication of the wireless terminal with the wireless base station causes no problem and thus the wireless terminal repeats such regular operation as shown in the drawing.

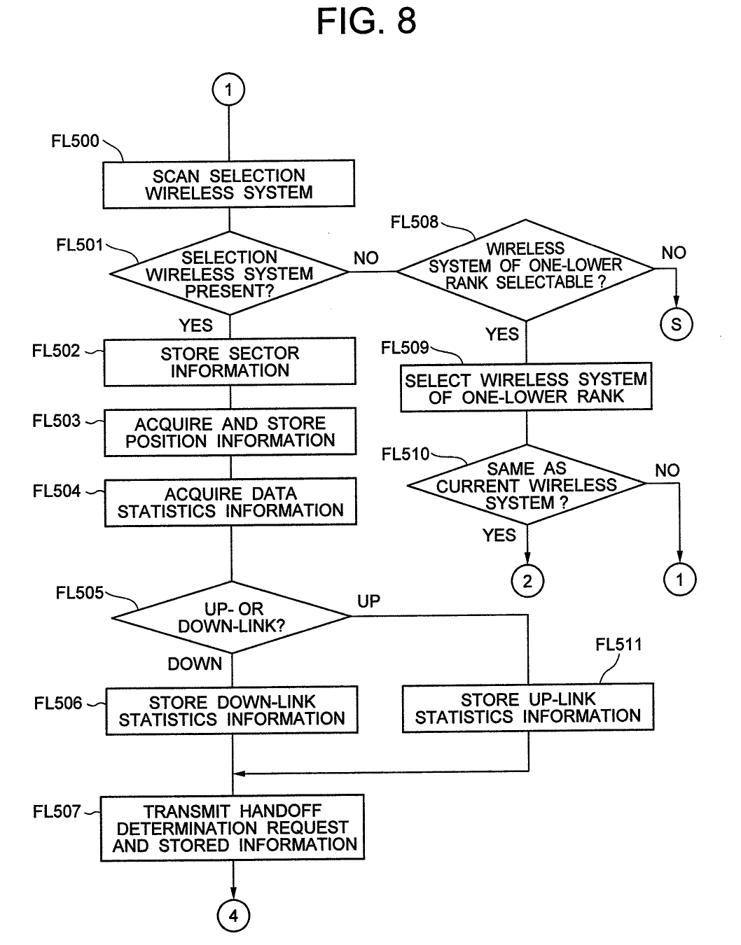

FIG. 8 shows a flowchart of operations after the wireless terminal selects a handoff destination candidate until the terminal transmits a handoff processing request to the call control device of the handoff destination candidate. The wireless terminal in the previous flowchart is assumed to select the wireless system of the handoff destination. The wireless terminal scans the selected wireless system to know whether or not the selected wireless system is in service in the area (step FL500). Since the wireless terminal has two or more wireless devices as shown in FIG. 3, the wireless terminal can perform the handoff processing request operation while maintaining the communication with the current wireless system. The wireless terminal scans the pilot signal transmitted from the wireless base station of the selected wireless system and confirms the presence of the pilot signal. When the wireless terminal determines that the terminal can communicate with the selected system in the area (step FL501), the wireless terminal stores information about a service sector from the pilot signal and broadcasting information in the memory device of the wireless terminal (step FL502). The “service sector information” as stated herein is a sector identifier which discriminates between wireless base stations as an example. When finishing storing the sector information, the wireless terminal acquires position information from the GPS receiver and stores the acquired information in the memory device (step FL503). The wireless terminal next acquires data statistics information so far measured and stored during communication (step FL504).

This data statistics information, which is statistics information managed by the wireless terminal, includes data quantity, throughput and packet error rate as an example. Since the value of the statistics information is regularly updated, the wireless terminal determines whether the wireless terminal is used with the main down-link communication or with the main up-link communication, for example, on the basis of the size of the statistics information measured for a time period (e.g., 5 minutes) from a past determined time until selection of a handoff destination candidate (step FL505). This depends on the application program used by the user of the wireless terminal. However, when the quantity of down-link data from the wireless base station to the wireless terminal is greater as in the case of download, the wireless terminal is considered to use mainly the down-link communication. Conversely when an application program is uploaded, the wireless terminal is considered to use mainly the up-link communication. The wireless terminal can determine the main use of down- or up-link communication on the basis of the value of the statistics information. In this case, when the wireless terminal determines the main use of the down-link communication, the terminal stores down-link statistic information in the memory device (step FL506). When the wireless terminal determines the main use of the up-link communication, the terminal stores up-link statistics information in the memory device (step FL511). And the wireless terminal sends these stored information together with a handoff determination request (step FL507).

When the wireless terminal determines the absence of a selected wireless system through scanning of the selected wireless system, the wireless terminal determines whether or not to be able to select a wireless system of a rank lower by one on the basis of the data shown in FIGS. 5A and 5B (step FL508).

At this time, when the wireless terminal already selects the wireless system of the lowest rank, the wireless terminal cuts off the call, or the communication quality may become worse possibly with the call cut off. However, since the wireless terminal keeps its communication state with the current wireless system, the wireless terminal returns to the regular operation of FIG. 7. When a wireless system of a rank lower by one is selectable, the wireless terminal selects the selectable wireless system (step FL509). The selection of the wireless system of a rank lower by one may cause selection of the wireless system as the current wireless system when a wireless system of a high rank is selected as a handoff candidate through a step FL 410 of FIG. 7. However, considering that the service of the current wireless system is provided with a single cell or that the service area of an adjacent wireless base station is absent as in a wireless LAN within a building, the wireless terminal determines, in another flowchart, the absence or presence of a handoff destination within the current wireless system in addition to the determination of the selected current wireless system (step FL510).

Explanation will next be made as to the operation when the current wireless system is selected.

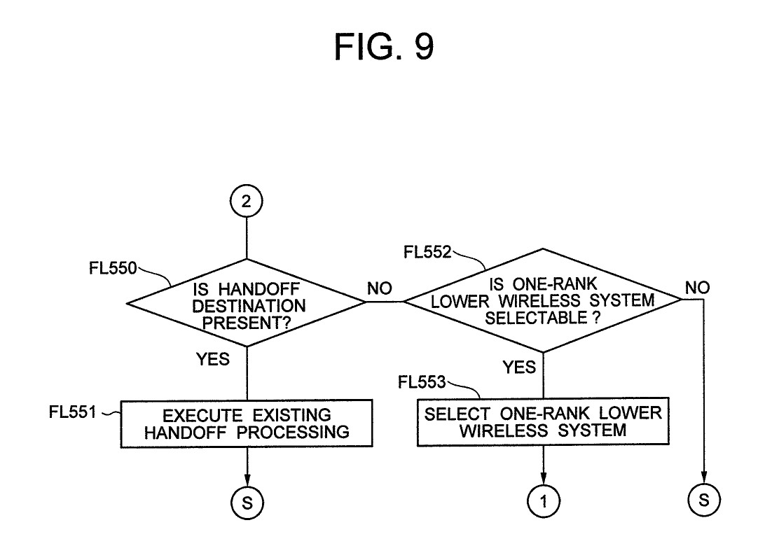

FIG. 9 is a flowchart of the operation when the current wireless system is selected. The illustrated example pays consideration to when the service of the current wireless system is provided with a single cell or when the service area of an adjacent wireless base station is not present, as in a wireless LAN within a building. When the wireless terminal first selects the current wireless system as a handoff destination candidate, the wireless terminal determines the presence or absence of a handoff destination in the same wireless system (step FL550). This is carried out according to the handoff method used in each wireless system. As a method of determining the presence or absence of a handoff destination, for example, when the wireless terminal is moved from one sector to another sector, the wireless terminal is moved away from the wireless base station currently in communication and thus the received power intensity of the pilot signal is decreased. However, since the wireless terminal is moving closer to the adjacent wireless base station, the received power intensity of the pilot signal is increased and thus the wireless terminal can confirm the pilot signal of the adjacent sector. Conversely, when the wireless terminal fails to detect the pilot signal of the adjacent sector, the wireless terminal can determine the absence of a handoff destination. When the wireless terminal determines that a handoff within the current wireless system is possible, the handoff is performed according to the method supported by the current wireless system (step FL551). After the handoff, the wireless terminal performs the regular operation of FIG. 7 in the handoff destination sector. When the wireless terminal determines the absence of a handoff destination within the current wireless system, the wireless terminal determines that a wireless system of a rank lower by one can be selected (step FL552). In the presence of a selectable wireless system, the wireless terminal starts scanning the selection wireless system in FIG. 8 to confirm whether the wireless terminal can be served in the wireless terminal presence area (step FL553). When a wireless system of a lower rank is absence and the wireless terminal cannot select it, the wireless terminal cuts off the call or the communication quality becomes worse possibly with the call cut off. However, since the wireless terminal keeps its communication state with the current wireless system, the wireless terminal returns to the regular operation of FIG. 7.

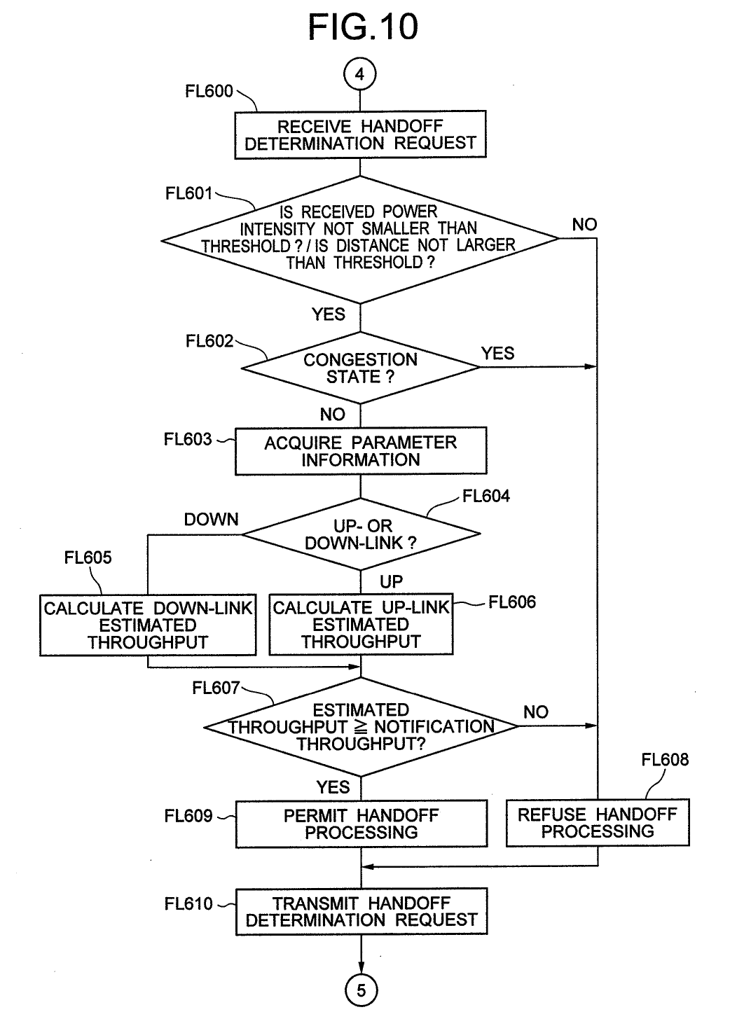

A handoff determination process in the call control device of a handoff destination candidate will then be explained by referring to FIG. 10.

In this drawing, it is assumed that the wireless terminal transmits a handoff determination request via the wireless system currently in communication.

When the call control device receives the handoff determination request from the wireless terminal (step FL600), the call control device first determines whether the received power intensity of the pilot signal obtained by the wireless terminal scanning the selected wireless system is not smaller than a threshold or a distance between the wireless terminal and the wireless base station is not larger than a threshold (step FL601). The determination of the received power intensity of the pilot signal can be carried out by comparing the received power intensity of the pilot signal informed by the wireless terminal with the threshold set for each wireless system. The distance between the wireless terminal and the wireless base station can be calculated by acquiring position information informed from the wireless terminal and position information of the sector from a sector identifier and by determining whether the distance is not larger than the threshold by comparison between the position information. Since the received power intensity of the pilot signal not higher than the threshold at the wireless terminal means that the electric wave of the selected wireless system is weak in the area, the call control device refuses the handoff processing operation. The distance between the wireless terminal and the wireless base station not smaller than the threshold means that the distance between the wireless terminal and the wireless base station is long. Since even the handoff to the selected wireless system leads to no expectancy of an improvement in the communication quality, the call control device refuses the handoff processing operation.

When the received power intensity of the pilot signal of the selected wireless system is sufficient or when the distance between the wireless terminal and the wireless base station is smaller than a certain threshold, an improvement in the communication quality of the service area having the wireless terminal present therein is expected from the viewpoint of an electric wave environment. Thus the wireless terminal next confirms whether or not the selected wireless system is in its congestion state (step FL602). The “congestion state” as stated herein is defined by a service provider and refers to the fact that the number of users exceeds a constant reference or the use rate of a CPU or a memory in various devices of the wireless system is higher than a certain threshold. In such a condition, the wireless terminal cannot perform new handoff processing operation. Thus when the selected wireless system is in the congestion state, the wireless terminal refuses the handoff processing operation. When the selected wireless system is not in the congestion state, the call control device acquires parameter information to calculate an estimated throughput (step FL635). The “parameter information” as stated herein refers to statistics information about throughput and so on regularly acquired, or refers to wireless system parameter information inherent to the device. The call control device determines the up- or down-link of the notified throughput stored in the handoff determination request from the wireless terminal (step FL604), and calculates an estimated throughput (steps FL605 and FL606) on the basis of the acquired parameter information. The estimated throughput is used as an index to compare the communication quality of the handoff destination candidate selected by the wireless terminal. When the wireless system selected by the wireless terminal is of not a best effort type but a guarantee type, the throughput is guaranteed and thus a guaranteed value is set for the estimated throughput.

When an estimated throughput is calculated or set, the call control device confirms whether or not the throughput information informed by the wireless terminal is lower than the estimated throughput (step FL607). When the call control device determines that the estimated throughput is higher than the current throughput, an improvement in the communication quality can be expected and thus the call control device permits the handoff processing operation to the wireless terminal (step FL609). Conversely when the estimated throughput is lower than the current throughput, an improvement in the communication quality cannot be expected and thus call control device refuses the handoff processing operation (step FL608). The handoff determination result is transmitted to the wireless terminal (step FL610). When the handoff destination candidate is of the best effort type, the estimated throughput is calculated on the basis of a distance between the wireless terminal and the wireless base station and the number of wireless terminals being connected in the sector as an example. This is based on the assumption that wireless terminals in the sector are not concentrated in a local area but uniformly distributed. On this assumption, an estimated throughput is calculated in accordance with an equation which follows.

(Estimated throughput)=(Maximum throughput)×[1/{(AT number)+1}×(X)]

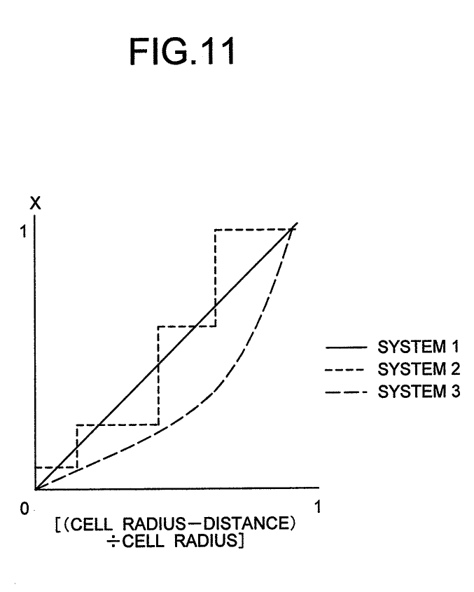

In the equation, “maximum throughput” denotes a maximum rate per sector supported by the wireless scheme, “AT number” denotes the number of wireless terminals present in the sector selected as a handoff destination candidate and is acquired from statistics information, and X is acquired from an equation, [(cell radius)−(distance)]/(cell radius), as shown by a graph of FIG. 11. “Cell radius” is acquired from system parameters within the respective wireless systems, “distance” denotes a distance between the wireless terminal and the wireless base station and is acquired from the position information transmitted from the wireless terminal and from the position information on the wireless base station. When a throughput is independent of the distance between the wireless terminal and the wireless base station as in the case of using power control, this can be attained by setting “X” in the graph at a fixed value to be parallel to a horizontal axis thereof. In this way, when a suitable graph is prepared for each wireless system, an equation considering geographical conditions and the features of the respective wireless systems can be used to calculate an estimated throughput.

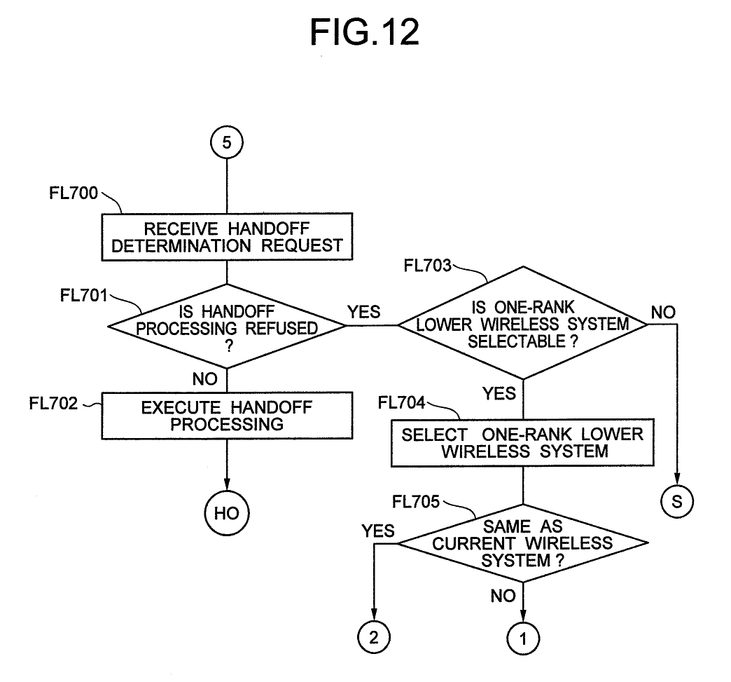

FIG. 12 is a processing flowchart when the wireless terminal receives the handoff determination result.

The processed result of the call control device as the handoff destination candidate explained in FIG. 10 is informed to the wireless terminal via the wireless system currently in use (step FL700), and the informed wireless terminal determines whether the handoff processing operation is permitted or refused (step FL701). When the handoff is permitted by the call control device, the wireless terminal performs the handoff processing operation to attain a call connection with the handoff destination wireless system via the current wireless system and the call control device (step FL702). With it, the wireless terminal starts performing the handoff processing operation to another wireless system. A mark “HO” given in a circle in the drawing means that the handoff processing operation was started. When the handoff processing operation is refused, the wireless terminal determines whether or not a wireless system of a rank lower by one can be selected (step fL703). When a selectable wireless system is present, the wireless terminals selects it (step FL704). When a wireless system of a rank lower by one than the wireless system first selected by the wireless terminal is selected in this way, the wireless terminal can select a plurality of wireless systems as handoff destination candidates and among the wireless systems, the wireless terminal can perform the handoff to the wireless system having an expectancy of an improved communication quality. When the selected wireless system is determined as the same as the current wireless system, control is shifted to a decision flowchart to know whether or not the handoff within the same wireless system can be performed. When the selected wireless system is determined as a different wireless system, control is shifted to a flowchart to start the handoff by scanning the selected wireless system (step FL705).

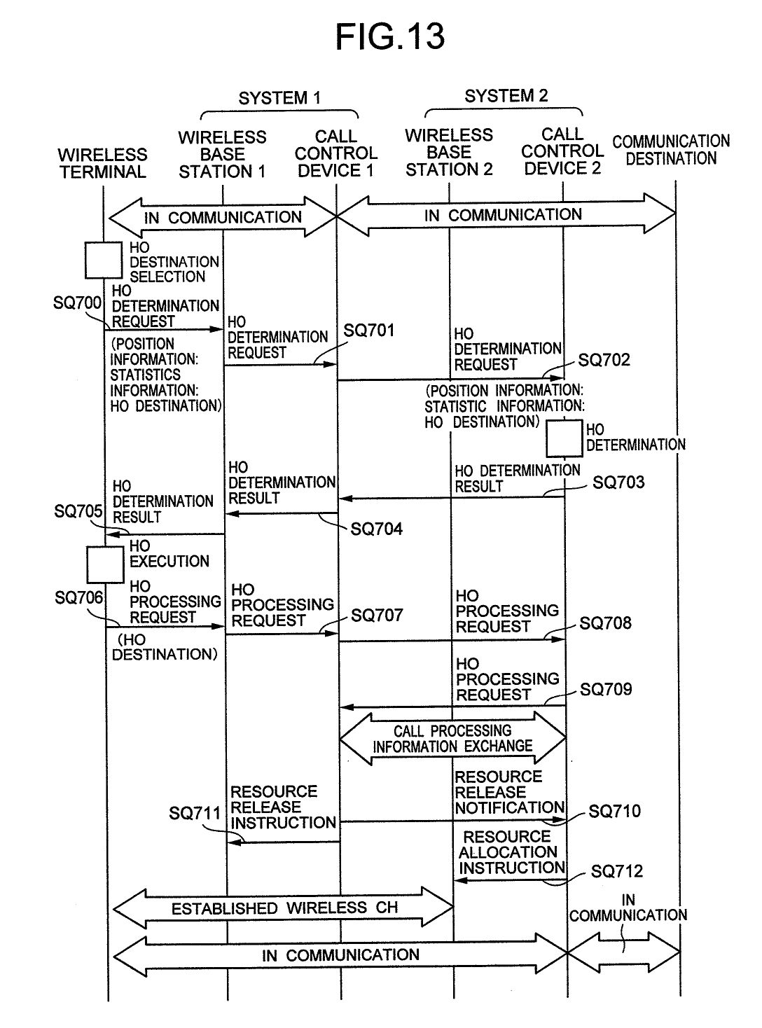

FIG. 13 shows a sequence chart for explaining the handoff between different wireless systems in the present invention.

In the drawing, two wireless systems are given as an example, a wireless base station 1 and a call control device 1 are present in the system 1, and a wireless base station 2 and a call control device 2 are present in the system 2. Squares as marks given in the chart mean to execute the aforementioned flowcharts. It is assumed in the chart that the wireless terminal is first communicating with a communication target via the wireless base station 1 and the call control device 1. When the handoff destination candidate is selected and the selected wireless system is already scanned in the wireless base station as mentioned above and when the presence of the handoff destination candidate is determined; the wireless terminal transmits an HO (HandOff) determination request to the wireless base station 1 (SQ700). The handoff determination request includes information to determine whether or not the call control device of the handoff destination performs the handoff. More specifically the information includes the position and statistics information of the wireless terminal, the sector identifier of the handoff destination candidate, and received power intensity of the pilot signal as given in FIGS. 5A and 5B. The wireless base station 1 when receiving the HO determination request transmits the request to the call control device 1 (SQ701). The call control device 1 when receiving the HO determination request, transmits the HO determination request to the call control device 2 to determine the execution or non-execution of the handoff between the different wireless systems (SQ702). The call control device 2 performs such handoff determination process as explained in FIG. 10 on the basis of the received information. In order to inform the wireless terminal of the processed result, the call control device transmits the HO determination result to the call control device 1 (SQ703). The call control device 1 when receiving the HO determination result, transmits the HO determination result to the wireless base station 1 (SQ704), and the wireless base station 1 in turn informs the wireless terminal of the HO determination result (SQ705). The wireless terminal when receiving the HO determination result performs the handoff according to such a flowchart as mentioned in FIG. 12. When receiving a handoff permission based on the HO determination result, the wireless terminal transmits the handoff processing request to the wireless base station 1 of the system currently in connection (SQ706). The wireless base station 1, when receiving the HO request, transmits it to the call control device 1 (SQ707), and the call control device 1 in turn prepares for the handoff processing operation. The call control device 1 transmits the HO request to the call control device 2 (SQ708). The call control device 2 transmits an HO response to the previously-received HO request to the call control device 1 of the system 1 (SQ709). The call control device 1 of the system 1, when receiving the HO response, communicates with the call control device 2 of the system 2, and transmits call processing information necessary for maintaining the handoff or the call connection to exchange the call processing information. When completing the exchange of the call processing information, the call control device 1 transmits a resource release notification to the call control device 2 to switch the communication destination of the wireless terminal from the system 1 to the system 2 (SQ710), and transmits a resource release instruction to the wireless base station 1 (SQ711). The call control device 2, when receiving the resource release notification, transmits a resource allocation instruction to secure a wireless resource between the wireless terminal and the wireless base station 2 (SQ712). When the wireless resource is secured by the wireless base station 2 to communicate with the wireless terminal, information on the wireless resource necessary for the communication is exchanged with the wireless terminal to establish a wireless channel. After the wireless channel is established, the wireless terminal communicates with the communication destination via the wireless base station 2 and the call control device 2 in the system 2. In this manner, when the wireless terminal performs the handoff between two wireless systems, the wireless terminal can select a wireless system having a high communication quality according to the moving speed of the terminal and can perform the handoff thereover.

It should be further understood by those skilled in the art that although the foregoing description has been made on embodiments of the invention, the invention is not limited thereto and various changes and modifications may be made without departing from the spirit of the invention and the scope of the appended claims.

1. A wireless terminal comprising:
a plurality of communication processors compatible with different wireless communication systems;
at least two antennas;
at least two wireless communication units for transmitting and receiving an electric wave in a communication system of any of said communication processors via the antennas;
a switch for switching between said plurality of communication processors and said wireless communication units;
a controller for controlling constituent elements of said wireless terminal; and
a terminal state detector,
wherein, when a state of the terminal detected by said terminal state detector satisfies a predetermined condition, said controller selects associated one of said wireless communication systems satisfying the condition and determines a communication quality in the selected wireless communication scheme, and, when an improvement in the communication quality is expected, said wireless terminal transmits a handoff determination request to said selected wireless communication scheme via said wireless communication unit and said antenna.

2. A wireless terminal according to claim 1, wherein the wireless communication systems compatible with said plurality of communication processors have different service areas and different throughputs respectively, and said wireless terminal includes a speed sensor as said terminal state detector to calculate a moving speed of the terminal as a terminal state and to select the wireless communication system defined by a threshold of the terminal moving speed.

3. A wireless terminal according to claim 2, wherein said wireless communication systems are previously ranked according to sizes of the service areas and to an average throughput, and, when the wireless terminal selects the wireless communication system defined by the threshold of said moving speed but cannot have an expectancy of an improvement in the communication quality, the wireless terminal further sequentially selects the wireless communication systems of lower ranks to determine the communication qualities.

4. A wireless terminal according to claim 1, wherein said communication quality determination is carried out for each of up- and down-links and the wireless terminal selects one of the wireless communication systems according to an amount of communication in the wireless terminal, with use of any one of the communication qualities of the up- and down-links as a reference.

5. A wireless terminal according to claim 2, the wireless terminal calculates an average moving speed as an index of the terminal moving speed, compares a calculated average moving speed with a previous-time average moving speed to determine an increase or decrease in the average moving speed, and compares the average moving speed with a threshold.

6. A method of performing a handoff between a plurality of wireless communication systems
each of said plurality of wireless communication systems comprising:
a wireless terminal comprising:
a plurality of communication processors compatible with said plurality of wireless communication systems of pre-defined ranks and having different service areas and different throughputs respectively;
at least two antennas;
at least two wireless communication units for transmitting or receiving an electric wave in any of the communication systems of the communication processors via the antennas;
a switch for switching between said plurality of communication processors and said wireless communication units;
a controller for controlling constituent elements of the wireless terminal; and
a terminal state detector,
a base station compatible with said plurality of wireless communication systems; and
a call control device connected to the base station compatible with said plurality of wireless communication systems and having handoff processing means for performing handoff processing operation between said plurality of wireless communication systems, the method has steps:
said controller selects one of the wireless communication systems having a rank satisfying the condition and determines a communication quality in the selected wireless communication system when a terminal state detected by said terminal state detector satisfies a predetermined condition and transmits a handoff determination request over said selected wireless communication system via said wireless communication unit and said antenna when an improvement in the communication quality is expected,
said call control device when receiving said handoff determination request, determines permission or non-permission of the handoff processing operation and transmits a handoff permission/non-permission determination result to said wireless terminal,
said wireless terminal performs the handoff when the handoff permission/non-permission determination result is permission,
selects the wireless communication system of another rank when the handoff permission/non-permission determination result is non-permission, and
transmits a handoff determination request via said wireless communication unit and said antenna when the selected wireless communication system is other than the wireless communication system currently being selected.

7. A method of performing a handoff between a plurality of wireless communication systems according to claim 6, wherein said wireless terminal includes a speed sensor as said terminal state detector, and the wireless terminal calculates a moving speed of the terminal as a state of the terminal and selects the wireless communication system defined by a threshold of the terminal moving speed.

8. A method of performing a plurality of wireless communication systems according to claim 7, wherein said ranks of the wireless communication systems are previously determined according to sizes of service areas of the wireless communication systems and to an average throughput and, when the wireless terminal selects the wireless communication system defined by said moving speed threshold but has no expectancy of an improvement in the communication quality, the wireless terminal sequentially selects the wireless communication systems of lower ranks to determine communication qualities.

9. A method of performing a handoff between a plurality of wireless communication systems according to claim 6, wherein said communication quality determination is carried out for each of up- and down-links, and selection of the wireless communication system is carried out according to an amount of communication in the wireless terminal with use of the communication quality of any of the up- and down-links as a reference.

10. A method of performing a handoff between a plurality of wireless communication systems according to claim 7, wherein said wireless terminal calculates an average moving speed of the terminal as an index of the terminal moving speed, compares a calculated average moving speed with a previous-time average moving speed to determine a decrease or increase in the average moving speed, and compares it with a threshold.
